(19) United States
(12) Patent Application Publication
(10) Pub. No.: US 2007/0147285 A1
(43) Pub. Date: Jun. 28, 2007

(54) Method and apparatus for transferring non-speech data in voice channel

(75) Inventors: Xiaohui Jin, Shanghai (CN); Yonggang Du, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/578,977

(22) PCT Filed: Nov. 3, 2004
(86) PCT No.: PCT/IB04/52279

§ 371 Date: May 10, 2006

(30) Foreign Application Priority Data
Nov. 12, 2003 (CN) 200310114289.1

(51) Int. Cl. H04Q 7/00; H04J 1/02

(52) U.S. Cl. 370/329; 370/493

(57) ABSTRACT

A method is provided for a mobile terminal to transmit non-speech data in voice channel, comprising: generating a non-speech data frame Tx (transmitting) indication according to the preset non-speech data frame Tx indication generating mode; generating a VAD (voice activity detection) flag about the next frame according to the non-speech data frame Tx indication; transmitting the non-speech data frame during the next frame if the VAD flag indicates that the next frame is non-speech period. With this method, IBD (In-Band Data) information can be transmitted timely, according to different requirements, for example, the urgency of IBD transmission, by selecting IBD data frame Tx indication generating mode.

### FIELD OF THE INVENTION

The present invention relates generally to a mobile communication method and apparatus, and more particularly to a method and apparatus for transferring non-speech data timely in the voice channel of cellular mobile communication systems.

### BACKGROUND ART OF THE INVENTION

In current 2 G/3 G mobile communication systems, speech signals and non-speech data are transferred respectively, with speech signals via the voice channel while non-speech data via dedicated data channel.

The processing flowchart of transferring speech signals between two conventional GSM MTs (mobile terminal) is shown in FIG. 1. As illustrated in the figure, before being transmitted to the network system, the speech signal to be transmitted at the transmitter side, is AD (Analog-to-Digital) converted by ADC 10, speech-compressed by speech compression unit 20, channel-coded by channel coding unit 30 and modulated by modulation unit 40 in Tx RSS (Radio SubSystem) 93. While at the receiver side, the received speech signal from the network system is demodulated by Rx demodulation unit 50 and channel-decoded by channel decoding unit 60 in Rx RSS 96, then speech-decompressed by speech decompression unit 70, and DA (Digital-to-Analog) converted by DAC 80. Thus, at last, the original speech signals transmitted by the sender MT are recovered after the aforementioned processing steps.

FIG. 2 is a block diagram illustrating conventional speech processing unit used in GSM full-rate speech traffic. The speech processing unit comprises the functional block of speech compression unit 20 used for transmitting data, as well as the functional block of speech decompression unit 70 used for receiving data. Additionally, ADC 10, Tx RSS 93, Rx RSS 96 and DAC Unit 80 are all included in FIG. 2 as well, to describe the complete procedure for transmitting/receiving speech signals.

As illustrated in FIG. 2, Tx DTX handler 90 comprises: speech encoder 901 (defined in GSM 06.10 standard), Tx DTX control & operation unit 902 (defined in GSM 06.31 standard), VAD (voice activity detector) 903 (defined in GSM 06.32 standard) and Tx comfort noise unit 904 (defined in GSM 06.12 standard). While Rx DTX handler unit 100 comprises: Rx DTX control & operation unit 1001 (defined in GSM 06.31 standard), speech decoder 1002 (defined in GSM 06.10 standard), speech frame substitution unit 1003 (defined in GSM 06.11 standard) and Rx comfort noise unit 1004 (defined in GSM 06.12 standard).

In GSM full-rate speech traffic, the VAD (Voice Activity Detection) is a critical module in implementing DTX (discontinuous transmission) mechanism, which decides when to output speech frames containing voice information and when to output SID (Silence Description) frames to generate background noise.

In FIG. 2, VAD 903 can be regarded as an energy detector, who adjusts its own VAD threshold according to the parameters provided by speech encoder 901, computes the energy of the current speech signal according to the signal from speech encoder 901, and compares the speech signal energy with the VAD threshold. If the speech signal energy is higher than the VAD threshold, then VAD=1, for indicating that current speech signal is valid, and thus DTX control & operation unit 902 sends the speech frames from speech encoder 901 to Tx RSS 93 during speech period; otherwise, VAD=0, for indicating that no speech signal is to be transmitted, thus DTX control & operation unit 902 sends the SID frames for generating background noise from Tx comfort noise unit 904 to Tx RSS 93 during non-speech period.

In mobile environment, the power of the background noise may vary continuously, thus the VAD threshold needs to be adjusted accordingly so that VAD 903 can distinguish speech signal and background noise timely and correctly. In order to provide an accurate detection result, the adjusted VAD threshold must be higher than the energy of the background noise, and thus the situation of misinterpreting noise signals as speech signals can be avoided. But the VAD threshold cannot be adjusted too high either, otherwise, speech signals with low power will be regarded as noise signals and thus discarded.

In the DTX technique that exploits VAD method, unnecessary radio transmission is reduced and thus radio interference is mitigated in the radio systems. Furthermore, the channel between the transmitter side and the network system and that between the receiver side and the network system are in low-rate transmission state during non-speech period, so normal speech communication won't be affected and the radio resource can be utilized more efficiently if non-speech data is transferred via voice channel at this moment. The non-speech data transferred via voice channel, is called IBD (In-Band Data). In the present invention, IBD includes all kinds of information except the speech data, such as image data, control signaling and etc.

A method for transferring non-speech data over voice channel during non-speech period, is described in the patent application entitled “A method and apparatus for transferring non-speech data in voice channel”, filed with the application by KONINKLIJKE PHILIPS ELECTRONICS N.V., Attorney's Docket No. CN030037, Application Serial No. 200310114288.7, and incorporated herein as reference.

In the above application, non-speech data can be transferred through adopting 3 types of IBD frames. Hereinafter, a description will be given to the modified speech processing unit that is capable of transferring non-speech data via voice channel.

Referring to the modified speech processing unit in FIG. 3, in Tx DTX handler 90 are added sending buffer 905 for storing IBD frames to be sent, and SendIBDFlag for indicating whether there are IBD frames to be sent in sending buffer 905. When upper-layer applications store IBD frames in sending buffer 905 via the data interface, SendIBDFlag is set to 1, to indicate there are IBD frames to be sent in sending buffer 905. When the stored IBD frames are sent to Tx RSS 93 according to the scheduling algorithm in Tx DTX control & operation unit 902, SendIBDFlag is set to 0, for indicating there is no data to be sent in sending buffer 905. In Rx DTX handler 100, DTX control & operation unit 1001 is modified adaptively to distinguish the 3 types of IBD frames, receiving buffer 1005 is added for storing the received IBD frames, and ReceiveIBDFlag is added for indicating whether there are IBD frames stored in receiving buffer 1005. When ReceiveIBDFlag=1, it indicates IBD frames are received, then upper-layer applications read the stored IBD frames through the data interface and decode the IBD frames into corresponding non-speech data according to the structure of the IBD frames; when ReceiveIBDFlag=0, it indicates there is no IBD frame in receiving buffer 1005.

When there are IBD frames to be sent, if VAD=1 at the transmitter side, the TX-DTX handler processes and transmits the speech frames in accordance with specifications in normal communication protocols; if VAD=0 and SendIBDFlag=0, SID frames will be processed and transmitted in accordance with specifications in normal communication protocols; if VAD=0 (non-speech period) and SendIBDFlag=1, IBD frames are transmitted. At the receiver side, once a frame is received, the RX-DTX handler will classify the received frame according to flags like BFI, SID and TAF, and then send the speech frame, SID frame or IBD frame into the corresponding processing module.

The present invention provides the methods for constructing, storing and sending IBD frames when IBD frames are to be sent via voice channel, and the methods for distinguishing, storing and reading IBD frames when IBD frames are received.

### SUMMARY OF THE INVENTION

On the basis of the above patent application, the present invention further proposes a method for transmitting IBD frames via voice channel according to practical requirements, e.g. the urgency or priority of the IBD transmission.

The object of the present invention is to provide a method and apparatus for transmitting non-speech data via voice channel. With the proposed method and apparatus, IBD information can be transmitted timely through selecting the IBD frame Tx indication generating mode, according to different requirements, e.g. the urgency to send the IBD.

A method is proposed for a mobile terminal (MT) to transmit non-speech data via voice channel in accordance with the present invention, comprising: generating a non-speech frame Tx (transmit) indication according to the preset non-speech frame Tx indication generating mode; generating a VAD (voice activity detection) flag about the next frame according to the non-speech frame Tx indication; transmitting the non-speech frame during the next frame if the VAD flag indicates that the next frame is non-speech period.

Said non-speech frame Tx indication generating mode can be set as generating Tx indication to transmit non-speech data frames immediately when there exist non-speech frames to be transmitted; or set as generating Tx indication to transmit non-speech data frame immediately once the Tx deadline of the non-speech frame to be transmitted expires; or set as corresponding the number of non-speech frames to be transmitted with said priority, and generating said non-speech frame Tx indication according to the number of said non-speech frames; or set as corresponding the urgency of said non-speech frame to be transmitted with said priority, and generating said non-speech frame Tx indication according to the urgency of said non-speech frame.

### BRIEF DESCRIPTION OF ATTACHED DRAWINGS

For a detailed description of the preferred embodiments of the present invention, reference will now be made to the accompanying drawings in which like reference numerals refer to like parts, and in which:

FIG. 1 is a schematic diagram illustrating the transmission of speech signals between two traditional GSM MTs;

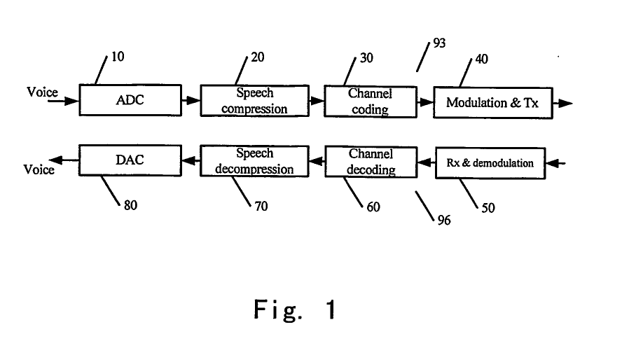

FIG. 2 is a block diagram illustrating the speech processing unit currently used in GSM full-rate speech traffic;

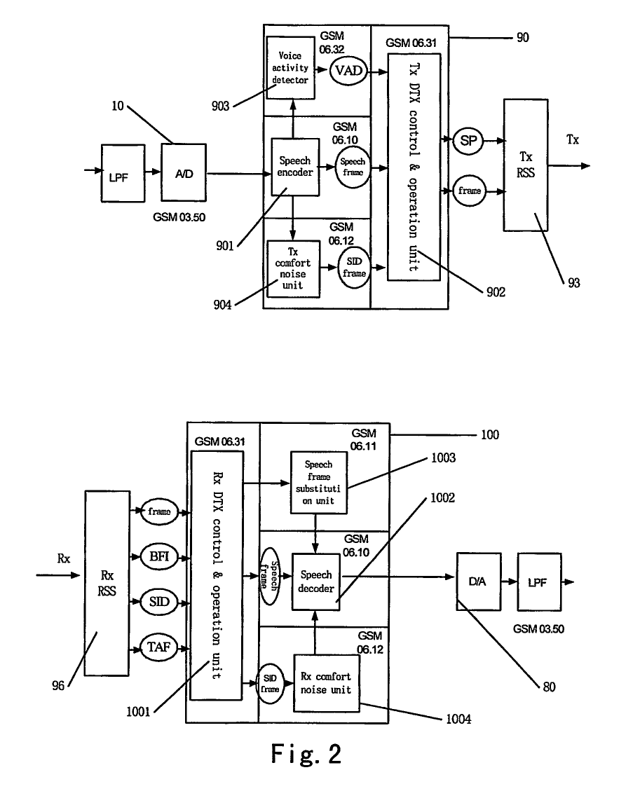

FIG. 3 is a block diagram illustrating the speech processing unit supporting IBD transmission via voice channel in GSM full-rate speech traffic;

FIG. 4 is a functional block diagram illustrating the TX-DTX when considering the urgency of transmitting IBD frames in accordance with the present invention;

FIG. 5 is a functional block diagram illustrating the VAD (Voice Activity Detector) when considering the urgency of transmitting IBD frames in accordance with the present invention;

FIG. 6 is a schematic diagram illustrating adjustment of the VAD threshold when considering the urgency of transmitting IBD frames in accordance with the present invention;

FIG. 7 is a flowchart illustrating adjustment of the VAD threshold when IBD frames are to be transmitted instantly, in accordance with the present invention;

FIG. 8 is a flowchart illustrating adjustment of the VAD threshold according to the priority of transmitting IBD frames, in accordance with the present invention.

### DETAILED DESCRIPTION OF THE INVENTION

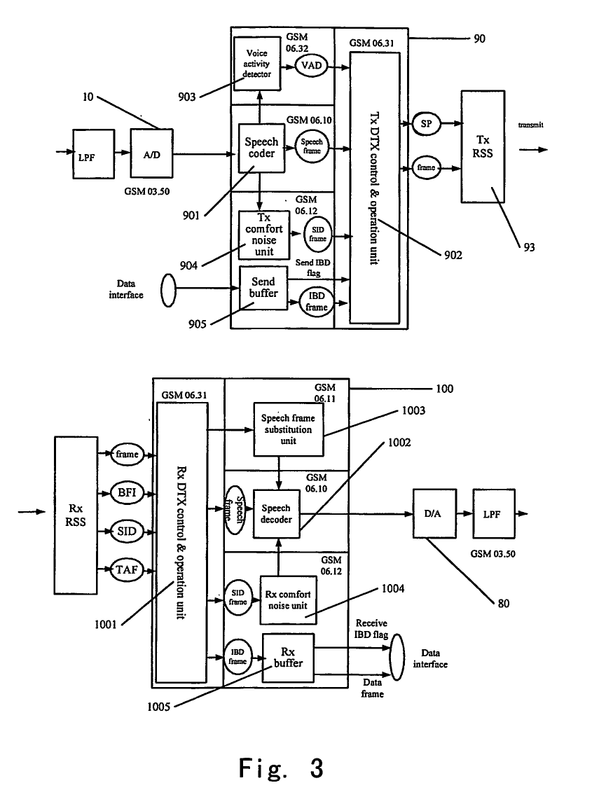

As described above, in the TX-DTX handler of FIG. 3, transmission of speech frames, SID frames and IBD frames can be switched according to the VAD flag generated by VAD 903, thus the timing of transmitting IBD frames can be selected by controlling the value of the generated VAD flag, based on the generation of the VAD flag.

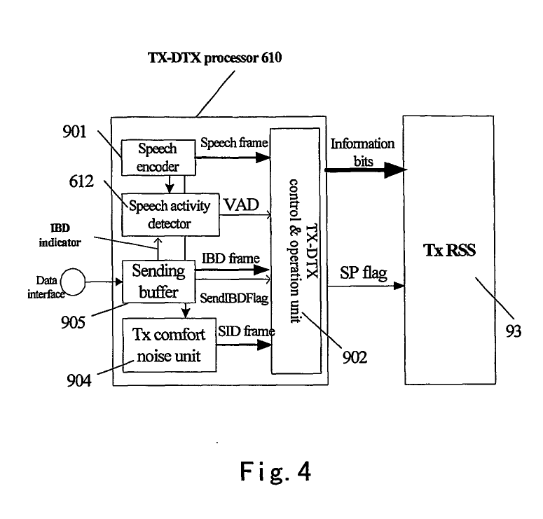

FIG. 4 illustrates the structure of the proposed TX-DTX processor when considering the urgency of IBD transmission. In FIG. 4, an IBD indicator, to be provided by sending buffer 905 to VAD 612, is added in TX-DTX processor 610, for representing the urgency of transmitting current IBD frame, for example.

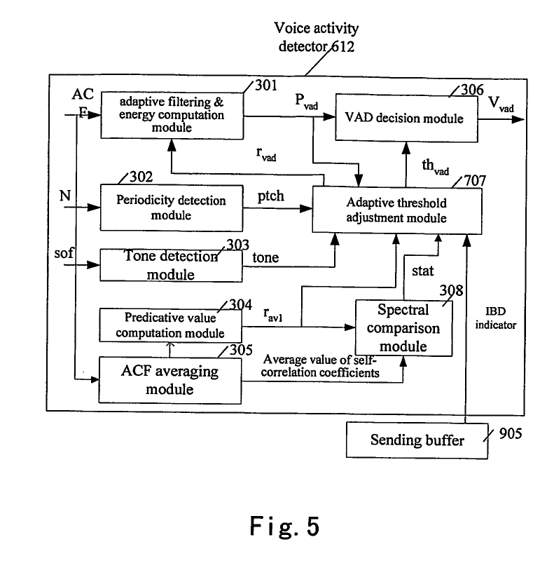

FIG. 5 displays the composition of VAD 612. According to the specifications of communication protocols, there is a non-speech period only if all the following conditions are met over a number of continuous signal frames: 1. Stationarity is detected in the frequency domain; 2. The signal does not contain a periodic component; 3. Information tones are not present. Once these conditions are met, VAD 612 will adjust its VAD threshold timely according to the background noise energy at that moment, to generate a correct VAD flag. To avoid affecting the transmission of normal speech signals, the VAD threshold adjustment should be made during non-speech period. A detailed description will be given below, to the adjustment procedure of the VAD threshold and the generation procedure of the VAD flag in VAD 612, with reference to relevant functional blocks in FIG. 5.

As illustrated in FIG. 5, parameter ACF is the autocorrelation coefficient (bearing information about the signal energy) generated in the encoding procedure of speech encoder 901. ACF is mainly used to compute signal energy in adaptive filtering & energy computation module 301.

First, let's consider the three conditions for judging whether there is no speech.

1. Stationarity in the Frequency Domain

The spectral information of a single 20 ms signal frame is not enough to represent the complete spectral characteristics of the input signal, so an information block of more than 20 ms is needed for computation. Thus, as shown in FIG. 5, the ACF is first sent to ACF averaging module 305, to average several continuous signal frames. Then, the average mount of the ACF is sent to predictor computation module 304, to compute the autocorrelation predictor r^{avl}. Spectral comparison module 308 computes the spectral characteristics of the input signal according to the average mount of the autocorrelation coefficients and the autocorrelation predictor r^{avl}, and compares it with the last computation result. If the difference between the two results is within the predefined range, stationarity in the frequency domain can be ensured; otherwise, it means some change occurs in the frequency domain. Finally, spectral comparison module 308 provides a parameter stat, for representing the stationary in the frequency domain, to adaptive threshold adjustment module 307.

2. Whether the Signal Contains a Periodic Component

Periodicity detection module 302 implements detection and judgment through comparing the long-time predictor lag value N of several continuous sub-frames, wherein the lag value N is gained through long-time prediction computation in the speech encoding procedure of speech encoder 901, for representing the maximum correlation peak position of two continuous signal frames in tandem over a long time period. If one of the two lag values in tandem is the factor of the other, there must be some correlation between the two lag values, and thus it can be judged that some periodic components exist in the signal. The detection result is denoted by parameter ptch, and ptch=1 represents the existence of periodic components.

3. Whether Information Tones are Present

Detection of information tones is very complicated, so it's often estimated by information tone detection module 303 after speech encoding of the current signal frame. The difference between information tone and ambient noise is that information tone has higher prediction gain. So, in practical applications, information tone detection module 303 applies prediction processing to the offset-compensated signals of from speech encoder 901, and compares the normalized prediction error with a threshold. If the prediction error is smaller than the threshold, it indicates information tones are present in the frame, then parameter tone=1; otherwise, the frame is noise.

Three parameters ptch, tone and stat from periodicity detection module 302, information tone detection module 303 and spectrum comparison module 308 are sent separately to adaptive threshold adjustment module 707. In VAD 612 of the present invention, adaptive threshold adjustment module 707 not only receives the three parameters ptch, tone and stat from periodicity detection module 302, information tone detection module 303 and spectrum comparison module 308, to judge whether there is speech period, but also receives the IBD indicator from sending buffer 905, to properly adjust the threshold thvad outputted from adaptive threshold adjustment module 707 according to conditions like the urgency of transmitting IBD frames, and sends the VAD threshold thvad to VAD decision module 306. At the same time, adaptive threshold adjustment module 707 delivers the autocorrelation predictor r^{vad} of the present signal frame to adaptive filtering & energy computation module 301, to set the filter's parameters.

VAD decision module 306 compares the energy P^{vad} of the signal frame from adaptive filtering & energy computation module 301 with the adjusted threshold th^{vad} from adaptive threshold adjustment module 707. If the energy of the signal frame is higher than the VAD threshold, the payload of the signal frame is valid speech, and the VAD flag V^{vad} outputted from VAD judgment module 306 is set to 1; otherwise, the payload of the signal frame is noise, and the VAD flag V^{vad} outputted from VAD judgment module 306 is set to 0.

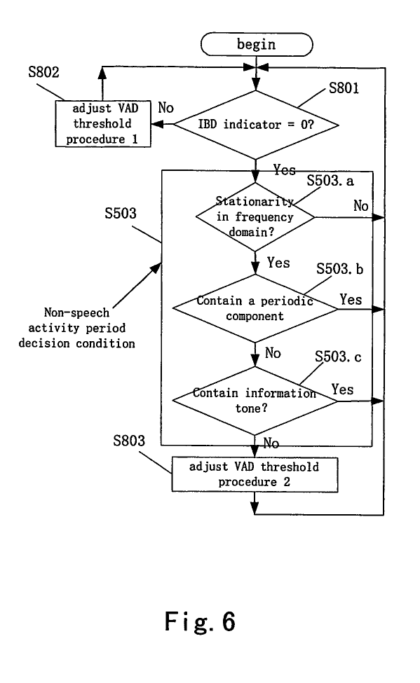

FIG. 6 is a schematic diagram illustrating the threshold adjustment procedure in accordance with the present invention. As shown in FIG. 6, threshold judgment starts from judging the IBD indicator (step S801). If the IBD indicator is not zero, it means that IBD frames should be sent in the next frame, then the VAD threshold need be adjusted immediately to satisfy the requirement of sending data, i.e. execute VAD threshold adjustment procedure 1 (step S802). If the IBD indicator is zero, IBD frames won't be sent for now and the flow goes into the condition judgment part about whether there is speech period in traditional algorithms (step S503). The three conditions will be judged in turn as: stationarity in frequency domain (step S503.a), whether periodic components exist (step S503.b) and whether information tones are present (step S503.c). Only when the three conditions are all satisfied at the same time, VAD threshold adjustment procedure 2 can be enabled (step S803). Note that the two VAD threshold adjustment procedures in FIG. 6 can utilize different adjustment parameters according to the urgency of the data to be transmitted, or even utilize completely different adjustment methods so that the threshold adjustment in the present invention can be more flexible.

In VAD threshold adjustment procedure 1 which is newly added into the present invention as shown in FIG. 6, the IBD indicator can be divided into two types: (I) The IBD indicator can be expressed as a Boolean variable (i.e. can only be 0 or 1) according to whether IBD frames need to be sent immediately. For example, 1 stands for sending IBD frames immediately and 0 stands for not sending IBD frames. (II) The VAD threshold is adjusted corresponding to different priority according to the priority of the IBD frames to be transmitted, and the adjusted VAD threshold is compared with the energy of the current signal frame, to determine whether to send IBD frames. In this situation, the IBD indicator can be of different values.

According to the present invention, how to represent the IBD indicator, i.e. to set IBD frame Tx indication generating mode, depends on practical requirements.

When the IBD indicator is a Boolean variable, the IBD indicator can be generated in the two following situations: (1) Once an IBD frame is stored in sending buffer 905, sending buffer 905 provides an IBD indicator with value as 1 to the VAD immediately; otherwise, sending buffer 905 provides an IBD indicator with value as 0 to the VAD. (2) When an IBD frame is being stored in sending buffer 905, timing of the IBD frame is started. The IBD indicator is set to 1 until the deadline or TTL (TTL: Time To Live) of the IBD frame expires; otherwise it is always 0. In other words, sending buffer 905 provides an IBD indicator with value as 1 to the VAD when the IBD frame stored in sending buffer 905 gets to the transmitting time; conversely, sending buffer 905 provides an IBD indicator with value as 0 to the VAD if the IBD frame doesn't get to the transmitting time yet. Depending on different requirements, UEs (User Equipments) can set the IBD frame Tx indication generating mode as generating the IBD indicator when there are IBD frames to be sent, or generating the IBD indicator when the IBD frame to be sent expires.

When the IBD indicator is of different values (integer or decimal fraction), the IBD indicator may fall into two situations: (1) When the IBD indicator denotes the number of IBD frames, the number of IBD frames stored in sending buffer 905 is corresponded with a certain priority and thus different number of IBD frames can be of different priority. Meanwhile, sending buffer 905 provides the number of the stored IBD frames as the IBD indicator to the VAD. (2) When the IBD indicator represents the urgency of the IBD frame, the urgency of the IBD frame stored in sending buffer 905 is corresponded with a certain priority, the higher the urgency is, the higher the priority will be. Meanwhile, sending buffer 905 provides the priority of the first IBD frame to be sent as the IBD indicator to the VAD. According to different requirements, UEs can set the IBD frame Tx indication generating mode as using the number of the stored IBD frames as the IBD indicator, or judging the priority of the IBD frames and providing the urgency as the IBD indicator to the VAD.

In the following section, examples will go to two situations as to whether there is any IBD frame in sending buffer 905 and the priority of the IBD frames stored in sending buffer 905, to describe the VAD threshold adjustment methods corresponding to when the IBD indicator is a Boolean variable and an integer respectively.

I. Generating the IBD Indicator when there are IBD Frames to be Sent in Sending Buffer 905

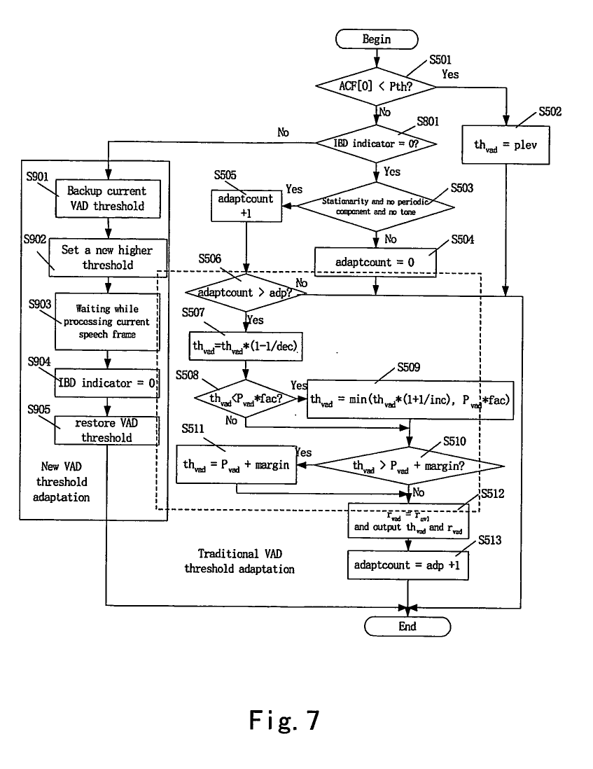

Referring to FIG. 7, at the transmitter side, when an IBD frame is stored into the IBD sending buffer, SendIBDFlag is set to 1, to tell the TX-DTX control & operation module that there is data to be sent in sending buffer 905. Herein, SendIBDFlag only indicates the existence status and can't indicate whether the IBD frame need be transmitted immediately or not. That is, synchronization between SendIBDFlag and the IBD indicator is not required, so SendIBDFlag and the IBD indicator can have completely different values.

As shown in FIG. 7, a judgment is first made on whether the energy of the current signal frame is below the lower limit pth of the acceptable signal energy (step S501), wherein the energy of the signal frame is represented by its autocorrelation coefficient ACF[0]. If the energy of the signal frame is below the lower limit, the VAD threshold th^{vad} will be set to a certain value plev (step S502). If the signal satisfies the energy requirement, the IBD indicator will be judged (step S801).

If the IBD indicator equals to 0, it indicates there is no need to send the IBD frame, then a judgment will be made on non-speech period conditions according to the specifications of the communication protocols (step S503). If it is during speech period currently (or the three conditions can't be satisfied at the same time), the threshold cannot be adjusted, so threshold adjustment counter adaptcount is set to zero (step S504), and the flow exits from this module. When the non-speech period conditions can be met, threshold adjustment counter adaptcount is increased by 1 (step S505). Next, a judgment is made on whether threshold adjustment counter adaptcount is above the predefined value adp (step S506), to decide whether the time of meeting non-speech period conditions gets to the predefined time. That means it really can be regarded as during non-speech period when said non-speech period conditions can be satisfied continuously over a certain time period. If said counter adaptcount is less than the predefined value adp, no more operation will be performed and the flow will exit from the present module. If said counter adaptcount is greater than the predefined value adp, a small mount, like 1/dec of th^{vad}, is first subtracted from the current threshold th^{vad} (step S507). Then, the adjusted th^{vad} is compared with the fac times of the energy P^{vad} of the current signal frame (step S508), wherein fac is a preset constant. If th^{vad} is comparatively smaller, the threshold value is increased by a small mount, like 1/inc of th^{vad}, and the smaller one between the added threshold and the fac times of P^{vad} will be taken as th^{vad} of the next frame (step S509), wherein inc and dec are both preset constants, such as 8, 16 or 32. Afterwards, a judgment is made on whether the adjusted th^{vad} exceeds the allowable upper limit, which is decided by the energy P^{vad} of the current signal frame added with some surplus (step S510). If th^{vad} is greater in the comparison result of step S508, step S510 will be executed directly. If threshold th^{vad} exceeds said upper limit in step S510, the VAD threshold th^{vad} is set to the upper limit (step S511). Finally, the threshold th^{vad} and autocorrelation predictor r^{vad} are outputted (step S512), and adaptcount is set to an invalid value (step S513), to avoid repeated VAD threshold adjustment during a non-speech period.

If the IBD indicator equals to 1, e.g. it's regulated in the present invention that an IBD frame will be sent immediately once it is stored in sending buffer 905, then once an IBD frame is stored in sending buffer 905, sending buffer 905 provides IBD indicator=1 to the VAD immediately and the flow goes to the proposed VAD threshold adjustment algorithm. In the present invention, in order to send the IBD frame immediately without affecting comparison of the VAD threshold of subsequent signal frames after said frame is transmitted, first, the VAD threshold used for processing the current frame is backed up (step S901), and then the newly adjusted VAD threshold is set as a value higher than the currently used VAD threshold (step S902). To create a good timing for IBD transmission, the new threshold must be higher than the energy P^{vad} of the current speech signal frame so that IBD can be transmitted via voice channel. With consideration of not affecting the processing of the current speech frame, the VAD flag should be set to zero for transmitting IBD frames until the completion of processing current speech frame. Therefore, the processing flow will go into waiting status after the VAD threshold adjustment, waiting for the completion of processing current speech frame (step S903). After current speech frame is processed, the adjusted VAD threshold is compared with the energy of the following speech frame. Because the adjusted VAD threshold is higher, the generated VAD flag is set to 0, thus the IBD frame can be sent out via voice channel. After the IBD frame is sent out, the IBD indicator is restored to zero (step S904), and the VAD threshold is restored to the backup threshold, to eliminate the possible influence caused by introducing higher threshold upon other subsequent speech frame processing (step S905).

In the aforementioned VAD threshold adjustment procedure, one or more non-speech periods are fabricated purposely at the transmitter side, with one or more IBD frames substituting one or more speech frames that were supposed to be sent. In the situation that the continuously transmitted IBD frames are not too many, substitution frame can be used in the RX-DTX to compensate the lost speech frame, without causing significant degradation of the voice quality. However, if the number of continuously transmitted IBD frames is higher than a preset criterion, (A1) e.g. the number of continuously transmitted IBD frames during the unit time is higher than a threshold, the communication quality will be affected. Thus, it's necessary to count the transmitted frames. When the number of the accumulatively transmitted IBD frames exceeds a preset criterion, transmission of IBD frames should be paused.

II. The IBD Indicator Represents the Priority of the IBD Frame to be Sent

As explained before, when the IBD indicator represents the priority of IBD frames stored in sending buffer 905, the IBD indicator is usually the priority of the first IBD frame to be sent in sending buffer 905. After the first IBD frame is sent out, sending buffer 905 will compute the priority of the next IBD frame, and take the priority of the next IBD frame as the priority of the whole current IBD frame sequence and set it as the IBD indicator.

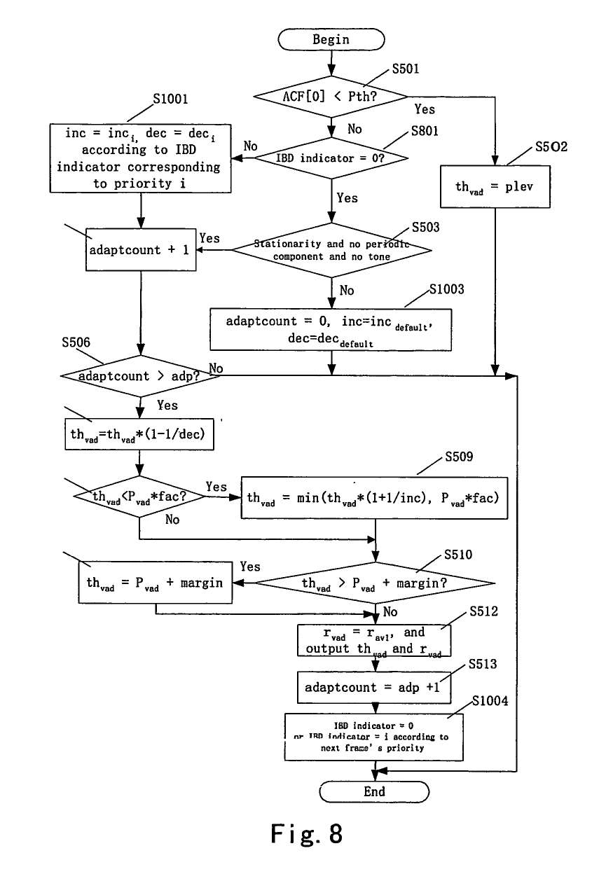

According to different values of the IBD indicator, the VAD will choose parameters corresponding to different step sizes, to adjust the VAD threshold to different extent. The detailed threshold adjustment procedure is displayed in FIG. 8: a judgment is first made on whether the energy of the current signal frame is below the lower limit pth of acceptable signal energy (step S501), wherein energy of the signal frame is represented by its autocorrelation coefficient ACF[0]. If the energy of the signal frame is below the lower limit, then the VAD threshold th^{vad} is set to a certain value plev (step S502). If the signal satisfies the energy requirement, the IBD indicator will be judged (step S801).

If the IBD indicator equals to 0 it means there is no need to send the IBD frame, and a judgment will be made about the non-speech period conditions according to the specifications in communication protocols (step S503). If the judgment result of step S503 shows that it is during a speech period, step S1003 will be executed, setting the increment inc and decrement dec as the default values respectively, and the VAD threshold adjustment procedure is over. If the judgment result of step S503 shows that it is during a non-speech period, the VAD threshold adjustment procedure from step S505 to step S513 will be executed, wherein step S503 to step S513 have corresponding steps as shown in FIG. 7. After the execution of step S513, the IBD indicator is still set to the previous value 0 (step S1004).

If the IBD indicator is not zero, e.g. the IBD indicator is the priority i of the first IBD frame in sending buffer 905 in the embodiment, then the parameter of the corresponding step size should be chosen according to the IBD indicator i, such as the increment incⁱ and decrement decⁱ, so as to determine the adjusted threshold with renewed parameters inc and dec in the threshold adjustment procedure (step S1001). The IBD indicator can be different corresponding to different priority i, and the chosen parameters used for VAD threshold adjustment are also different according to different IBD indicator, therefore, the step size for VAD threshold adjustment can vary with different priority. Then, the VAD threshold adjustment procedure is executed from S505 to S513. After the adjusted threshold th^{vad} is outputted, the IBD indicator is set to the corresponding value in step S1004 according to the priority of the next frame from sending buffer 905.

In this embodiment, except for setting parameters inc and dec as relevant values of the priority of the IBD frame in step S1001, subsequent threshold adjustment steps from S505 to S513 are similar to the corresponding steps when the IBD indicator is zero.

In the second embodiment of the present invention, different priority corresponds to different step size for threshold adjustment. For example, assuming there are 8 priority levels, then there should exist 8 different step sizes for the VAD threshold adjustment. In the case of higher priority, the step size may be bigger and the corresponding threshold adjustment range may be wider too. As long as the energy of the next frame is lower than the adjusted threshold, it will be judged as noise, and thus the IBD frame with said priority can be transmitted immediately. For an IBD frame with lower priority, the threshold adjustment range is also relatively smaller, so speech frames with high energy can still be transmitted normally. Only when a speech frame arrives with energy lower than the adjusted threshold, the IBD frame can substitute the speech frame and be sent out.

Detailed description is offered above to the present invention in connection with two embodiments. It should be noted that the IBD indicator may not be limited to the aforementioned four types, and the IBD indicator can be generated by sending buffer 905 of the present invention or by any other IBD indicator generators.

The proposed method for transmitting non-speech data in voice channel can be implemented in software or hardware modules, or in combination of both, and its principle and implementation can equally be applied to other GSM speech traffics as well.

### BENEFICIAL RESULTS OF THE INVENTION

As clearly explained in the above description in conjunction with accompany drawings, the proposed method for timely transmitting non-speech data in voice channel, can directly adjust the previously set VAD threshold according to the urgency of the IBD frame, so IBD transmission can be implemented flexibly and timely.

With regard to the method in the present invention, the VAD indicator will not be generated immediately after the VAD threshold is adjusted according to requirement, and the comparison between the adjusted VAD threshold and the energy of the signal frame won't occur until processing of the current frame is over, so it won't affect the ongoing speech frame processing.

Additionally, in the implementation procedure of the present invention, the lost of speech frames caused by VAD threshold adjustment, can be compensated through frame substitution at the receiver side, and thus the voice quality won't be deteriorated to human hearing (or there is only a very small loss in voice quality).

Moreover, regarding to the proposed method for transmitting non-speech data via voice channel, modifications only involve the VAD threshold adjustment method, instead of changes in the mobile terminal and network system hardware, so it is easy to be implemented on the basis of traditional mobile terminal hardware.

Furthermore, it's to be understood by those skilled in the art that, the method of adjusting VAD threshold, disclosed in this invention can be modified considerably without departing from the spirit and scope of the invention as defined by the appended claims.

What is claimed is:

1. A method for a mobile terminal to transmit non-speech data in voice channel, comprising:
(a) generating a non-speech data frame Tx (transmitting) indication according to the preset non-speech data frame Tx indication generating mode;
(b) generating a VAD (voice activity detection) flag about the next frame according to the non-speech data frame Tx indication;
(c) transmitting the non-speech data frame during the next frame if the VAD flag indicates that the next frame is non-speech period.

2. The method of claim 1, wherein step (b) further includes:
adjusting the VAD threshold currently used by the mobile terminal according to said non-speech data frame Tx indication;
generating the VAD flag of the next frame according to the adjusted VAD threshold.

3. The method of claim 2, wherein step (b1) further includes:
backing up the current VAD threshold;
setting a value higher than the current VAD threshold as the adjusted VAD threshold;
restoring the adjusted VAD threshold to the backup VAD threshold after executing said step (c).

4. The method of claim 3, wherein said non-speech data frame Tx indication generating mode can be set to generate the Tx indication to transmit said non-speech data frame instantly when there exists said non-speech data frame to be transmitted.

5. The method of claim 3, wherein said non-speech data frame Tx indication generating mode can be set to generate the Tx indication to transmit said non-speech data frame instantly when the Tx deadline of the non-speech data frame to be transmitted expires.

6. The method of claim 2, wherein step (b1) further includes:
selecting parameters corresponding to different priority according to said non-speech data frame Tx indication;
adjusting the current VAD threshold to the values corresponding to different priority, by using the selected parameters.

7. The method of claim 6, wherein said non-speech data frame Tx indication generating mode can be set to correspond the number of said non-speech data frames to be transmitted with said priority, and to generate said non-speech data frame Tx indication according to the number of said non-speech data frames.

8. The method of claim 6, wherein said non-speech data frame Tx indication generating mode can be set to correspond the urgency of said non-speech data frames to be transmitted with said priority, and to generate said non-speech data frame Tx indication according to the urgency of said non-speech data frame.

9. The method of claim 1, further comprising:
counting the number of non-speech data frames to be transmitted;
judging whether the counted number exceeds a predefined criterion;
pausing transmission of said non-speech data frames if the counted number exceeds the predefined criterion;

10. A mobile terminal capable of transmitting non-speech data in voice channel, comprising:
an indication generating unit, for generating a non-speech data frame Tx indication according to the preset non-speech data frame Tx indication generating mode;
a VAD flag generating unit, for generating a VAD flag about the next frame according to the non-speech data frame Tx indication;
a transmitting unit, for transmitting the non-speech data frame during the next frame if the VAD flag indicates that the next frame is non-speech period.

11. The mobile terminal of claim 10, wherein said VAD flag generating unit further includes:
an adjusting unit, for adjusting the VAD threshold currently used by said mobile terminal according to said non-speech data frame Tx indication;
said VAD flag generating unit, for generating the VAD flag of said next frame according to the adjusted VAD threshold.

12. The mobile terminal of claim 11, wherein said adjusting unit further includes:
a backup unit, for backing up said current VAD threshold;
a setting unit, for setting a value higher than said current VAD threshold as the adjusted VAD threshold;
a restoring unit, for restoring said adjusted VAD threshold to the backup VAD threshold after transmitting said non-speech data frames.

13. The mobile terminal of claim 12, wherein said non-speech data frame Tx indication generating mode can be set to generate the Tx indication to transmit said non-speech data frames instantly when there exist said non-speech data frames to be transmitted.

14. The mobile terminal of claim 12, wherein said non-speech data frame Tx indication generating mode can be set to generate the Tx indication to transmit said non-speech data frames instantly when the Tx deadline of the non-speech data frames to be transmitted expires.

15. The mobile terminal of claim 11, wherein said adjusting unit further includes:
a selecting unit, for selecting parameters corresponding to different priorities according to said non-speech frame Tx indication; said adjusting unit, for adjusting said current VAD threshold to the value corresponding to different priority with the selected parameters.

16. The mobile terminal of claim 15, wherein said non-speech data frame Tx indication generating mode can be set to correspond the number of said non-speech data frames to be transmitted with said priority, and to generate said non-speech data frame Tx indication according to the number of said non-speech data frames.

17. The mobile terminal of claim 15, wherein said non-speech data frame Tx indication generating mode can be set to correspond the urgency of said non-speech data frame to be transmitted with said priority and to generate said non-speech data frame Tx indication according to the urgency of said non-speech data frame.

18. The mobile terminal of claim 10, further comprising:
a counter, for counting the number of non-speech frames to be transmitted;
a judging unit, for judging whether the counted number exceeds a predefined criterion;
a control unit, for pausing transmission of said non-speech frames.
